(19) United States
(12) Patent Application Publication
(10) Pub. No.: US 2025/0331969 A1
(43) Pub. Date: Oct. 30, 2025

(54) CLAMPING HOLDER FOR A DENTAL BLANK

(71) Applicant: Ivoclar Vivadent AG, Schaan (LI)

(72) Inventors: Patrick MEIER, Ludesch (AT); Muhamed JASAREVIC, Bludenz (AT); Andreas HABIT, Tschagguns (AT)

(21) Appl. No.: 19/191,319

(22) Filed: Apr. 28, 2025

(30) Foreign Application Priority Data
Apr. 29, 2024 (EP) 24172991.2

(51) Int. Cl. A61C 13/12; A61C 13/00

(52) U.S. Cl. CPC A61C 13/12; A61C 13/0022

(57) ABSTRACT

A clamping holder (100) for a dental blank (103), having a first and a second clamping element (105-1, 105-2) for clamping the dental blank (103); and a magnetic mechanism (107-1, 107-2) for pushing apart the first and second clamping elements (105-1, 105-2) in an opening position.

### CROSS-REFERENCE TO RELATED APPLICATIONS

This application claims priority to European Patent Application No. 24172991.2 filed on Apr. 29, 2024, the disclosure of which is incorporated herein by reference in its entirety.

### TECHNICAL FIELD

The present invention relates to a clamping holder for a dental blank and a method of clamping a dental blank in a clamping holder.

US20110268525 is directed to milling tools and is hereby incorporated by reference in its entirety.

### SUMMARY

It is often difficult to open a clamping holder and remove a dental blank with existing clamping holders. Removal is possible if the material disk of the dental blank, including the ring-shaped clamping element, is pressed upwards through the clamping holder from below. However, this procedure is not intuitive at the beginning but has to be learned with great effort. However, a user needs to be able to change and clamp a dental blank as easily and safely as possible. In doing so, it is important that the handling is as simple and intuitive as possible.

Previously, the problem was solved by pressing a clamping element together with the dental blank from the bottom upwards and removing them together. The typical procedure here is to turn over the entire clamping holder with the dental blank and the ring-shaped clamping element so that the clamping element and the dental blank slide out of the clamping holder together. The clamping element can then be separated from the dental blank.

It is therefore the technical task of the present invention to facilitate the removal of a dental blank from a clamping holder.

This task is solved by subject-matter according to the independent claims. Advantageous embodiments are the subject-matter of the dependent claims, the description and the figures.

According to a first aspect, the technical task is solved by a clamping holder for a dental blank, comprising a first and a second clamping element for clamping the dental blank; and a magnetic mechanism for pushing apart the first and second clamping elements in an opening position. The magnetic mechanism has the technical advantage that the clamping elements of the clamping holder can be separated from each other in the opening position, making it easier to insert the dental blank. Handling during tool-free clamping of the dental blank is further improved. The magnetic mechanism also provides the user with haptic and acoustic feedback when opening the clamping holder. The position of the clamping element for removal is raised and held. This results in a clamping system that is intuitive and as easy to use as possible.

In a technically advantageous embodiment of the clamping holder, the magnetic mechanism is formed by a first magnetic element in or on the first clamping element and a second magnetic element in or on the second clamping element. This achieves the technical advantage, for example, that the magnetic mechanism can be implemented in a simple manner.

In a further technically advantageous embodiment of the clamping holder, the first magnetic element and the second magnetic element are arranged with the same polarity. In this homopolar arrangement, the two north poles or the two south poles of the magnetic elements are opposite each other. A repulsive force is created between the magnetic elements in the homopolar arrangement. This achieves the technical advantage, for example, that a strong force is generated to push the clamping elements apart.

In a further technically advantageous embodiment of the clamping holder, the first and/or the second clamping element comprises a ferromagnetic material. This achieves the technical advantage, for example, that the magnetic elements can interact with the respective ferromagnetic material in the opposite clamping holder.

In a further technically advantageous embodiment of the clamping holder, the first and/or the second magnetic element is arranged such that a clamping force is exerted between the first clamping element and the second clamping element in a closing position. This achieves the technical advantage, for example, that mounting of the dental blank in the closing position is improved and unintentional loosening of the clamping elements is prevented.

In a further technically advantageous embodiment of the clamping holder, the first and second magnetic elements are displaceable or rotatable relative to each other. This achieves the technical advantage, for example, that the forces between the clamping elements can be easily changed by the magnetic elements.

In a further technically advantageous embodiment of the clamping holder, the first magnetic element is integrated in a contact surface of the first clamping element to the second clamping element and/or the second magnetic element is integrated in a contact surface of the second clamping element to the first clamping element. This achieves the technical advantage, for example, that an integral structure is achieved and forces are transmitted efficiently between the clamping elements.

In a further technically advantageous embodiment of the clamping holder, the first clamping element comprises several magnetic elements and/or the second clamping element comprises several magnetic elements. This achieves the technical advantage, for example, that forces can be transmitted evenly between the clamping elements.

In a further technically advantageous embodiment of the clamping holder, the magnetic elements are arranged around a recess for inserting the dental blank. This achieves the technical advantage, for example, that a uniform opening of the clamping holder is achieved.

In a further technically advantageous embodiment of the clamping holder, the first and/or the second magnetic element comprises neodymium. This achieves the technical advantage, for example, that the magnetic mechanism can generate strong forces.

In a further technically advantageous embodiment of the clamping holder, the first and/or the second clamping element is C-shaped or ring-shaped. This achieves the technical advantage, for example, that the dental blank is held in an embracing manner.

According to a second aspect, the technical task is solved by a method of clamping a dental blank in a clamping holder, comprising the steps of clamping the dental blank between a first clamping element and a second clamping element; and pushing apart the first and second clamping elements in an opening position by a magnetic mechanism. The method achieves the same technical advantages as the clamping holder according to the first aspect.

In a technically advantageous embodiment of the method, a clamping force between the first clamping element and the second clamping element is exerted by the magnetic mechanism in a closing position. This achieves the technical advantage, for example, that the clamping of the dental blank between the clamping elements is improved and unintentional loosening of the clamping elements is prevented.

In a further technically advantageous embodiment of the method, the first and second clamping elements are pushed apart at several positions by the magnetic mechanism. This achieves the technical advantage, for example, that the 20 clamping elements can be pushed apart evenly.

In a further technically advantageous embodiment of the method, the first and second clamping elements are rotated between the opening position and the closing position. This achieves the technical advantage, for example, that the different effects of the magnetic mechanism can be realized in a simple manner.

### BRIEF DESCRIPTION OF THE DRAWINGS

Exemplary embodiments of the invention are shown in the drawings and are described in more detail below, in which:

FIG. 1 shows a perspective view of a clamping holder;

FIG. 2 shows another perspective view of the clamping holder in an opening position;

FIG. 3 shows another perspective view of the clamping holder in the opening position;

FIG. 4 shows a perspective view of the clamping holder in the closing position;

FIG. 5 shows another perspective view of the clamping holder in the closing position;

FIG. 6 shows a top view of a clamping holder in a transitional position;

FIG. 7 shows another perspective view of the clamping holder in the closing position; and

FIG. 8 shows a block diagram of a method of clamping dental objects.

### DETAILED DESCRIPTION

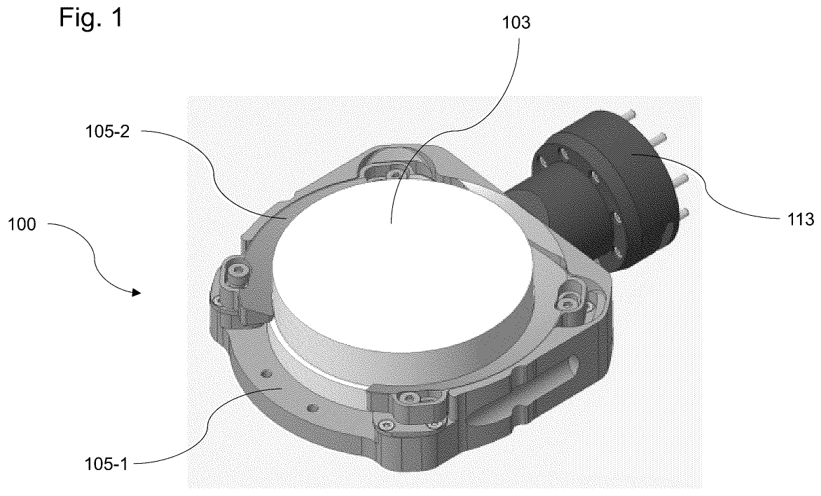

FIG. 1 shows a perspective view of a tool-free clamping holder 100 for clamping a dental blank 103. The clamping holder 100 is used to clamp a dental blank 103 for processing in a processing machine, such as a milling machine. The dental blank 103 is formed by a circular disk and is made of zirconium dioxide, for example. In general, however, the dental blank 103 and the corresponding clamping holder 100 can also have a different shape.

When processing the dental blank 103, it is held between a first clamping element 105-1 and a second clamping element 105-2 of the clamping holder 100. The clamping element 105-1 forms a base body and the clamping element 105-2 forms a clamping ring. During processing, individual dental objects, such as crowns or bridges, are milled out of the dental blank 103. The clamping holder 100 is attached to the processing machine via a mechanical interface 113.

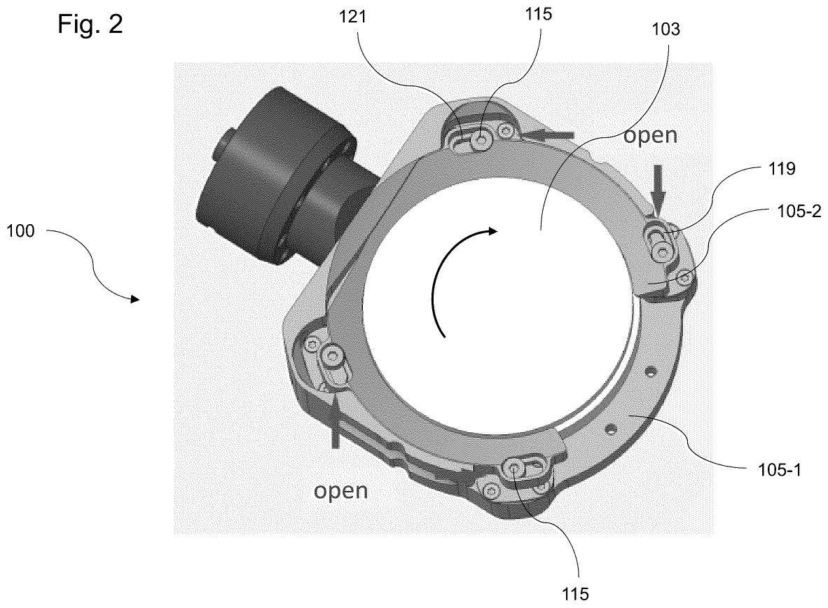

FIG. 2 shows another perspective view of the clamping holder 100 in an opening position. In the opening position, the first clamping element 105-1 and the second clamping element 105-2 can be separated from each other and the dental blank 103 can be inserted between the two clamping elements 105-1 and 105-2. In this way, a new dental blank 103 can be arranged between the two clamping elements 105-1 and 105-2. Here, the clamping pins 115 are located in slot-shaped openings 121 which can be displaced along the slot around the clamping pin 115. In the opening position, the clamping pins 115 can be moved out of the openings 121.

The two clamping elements 105-1 and 105-2 can be brought into a closing position by rotating them in the direction of the arrow. In the process, lateral protrusions 119 within the opening 121 engage behind a head of the clamping pin 115, so that a positive fit is achieved. The clamping elements 105-1 and 105-2 cannot be separated from each other in the closing position. In addition, the clamping pins 115 exert a tensile force or clamping force between the two clamping elements 105-1 and 105-2, so that the dental blank 103 is held between them.

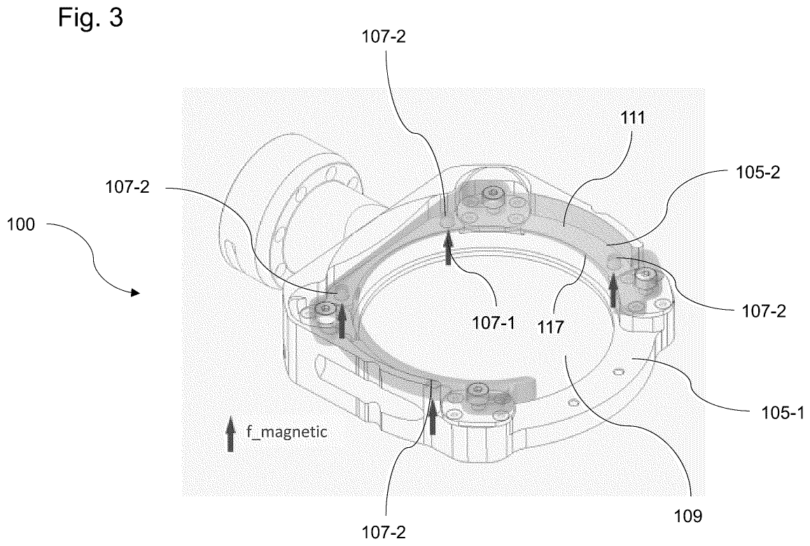

FIG. 3 shows another perspective view of the clamping holder 100 in the opening position. The clamping element 105-1 comprises several magnetic elements 107-1, which are integrated in a contact surface 111 to the other clamping element 105-2 and which are arranged around an opening 109 for inserting the dental blank 103. Equally, the clamping element 105-2 also comprises several magnetic elements 107-2 which are integrated in an opposite contact surface 117 to the other clamping element 105-1 and which are also arranged around the opening 109 for inserting the dental blank 103.

In the opening position, the magnetic elements 107-1 and 107-2 lie opposite each other in pairs respectively and repel each other, as they are oriented with the same polarity to each other. This results in a repulsive magnetic force that pushes the clamping elements 105-1 and 105-2 apart in the direction of the arrow in the opening position. The magnetic elements 107-1 and 107-2 therefore create a magnetic mechanism for the clamping holder 100 to push apart the clamping elements 105-1 and 105-2.

This supports the removal of the clamping element 105-2 from the clamping holder 100. It is easily possible to remove the clamping element 105-2, as it is positioned in a raised manner in the base body of the underlying clamping element 105-1 and the magnetic force lifts the clamping element 105-2. The magnetic levitation also makes it possible to tilt the clamping element 105-2, which further simplifies the removal of the dental blank 103.

In the embodiment shown, four homopolar pairs of magnetic elements 107-1 and 107-2 are used, which are distributed around the opening 109. In general, however, a different number of magnetic elements 107-1 and 107-2 can also be used, arranged in a different manner in the clamping elements 105-1 and 105-2.

When four magnets are arranged, a force of at least 6.5 to 7.5 N should be applied between the first and second clamping elements 105-1, 105-2. In a real design, four magnets with dimensions of 5 mm×3 mm with a joint force of 6.9 N can be used.

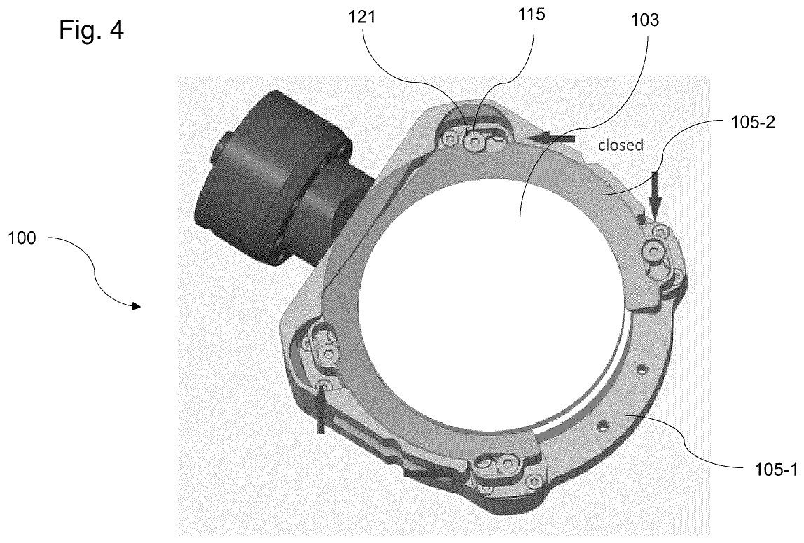

FIG. 4 shows a perspective view of the clamping holder 100 in the closing position. In the closing position, which is achieved by rotating the clamping elements 105-1 and 105-2 relative to one another, the clamping pins 115 are located at the opposite stop of the slot-shaped openings 121. In the closing position, the lateral protrusions 119 within the openings 121 engage behind the respective head of the clamping pin 115. In this way, the two clamping elements 105-1 and 105-2 are coupled to one another. The movable clamping pins 115 are subjected to a force which is transmitted to the clamping elements 105-1 and 105-2 as a tensile force or clamping force. A spring, for example, can be used to exert the tensile force or clamping force.

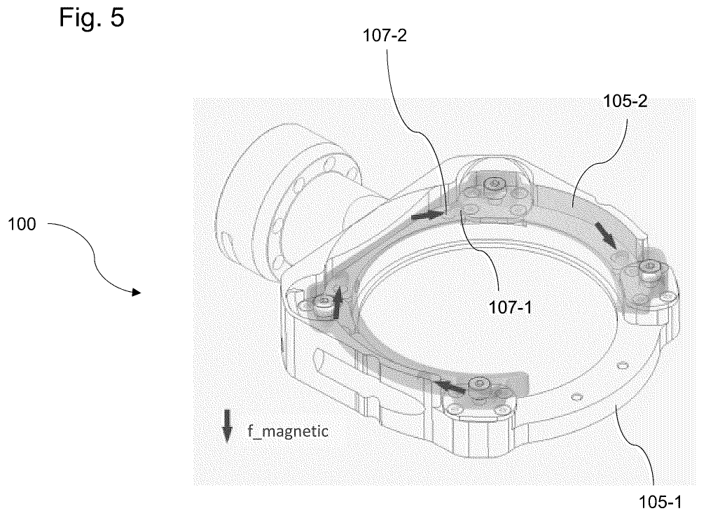

FIG. 5 shows another perspective view of the clamping holder 100 in the transitional position to the closing position. In the transitional position, the magnetic elements 107-1 and 107-2 from the upper and lower clamping holder 105-1 and 105-2 are displaced relative to each other so that the magnetic poles are separated from each other. In this case, there is no longer any magnetic force pushing the clamping elements 105-1 and 105-2 apart. An additional lateral force helps the clamping element 105-2 to engage in the closing position of the end stop.

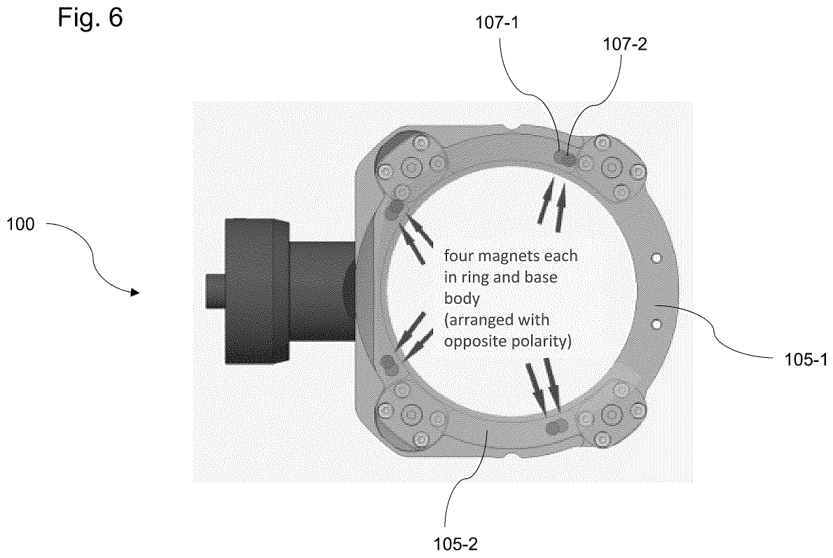

FIG. 6 shows a top view of the clamping holder 100 in the closing position and the arrangement of the magnetic elements 107-1 and 107-2 in the respective clamping elements 105-1 and 105-2. In order to bring the clamping element 105-2 into the closing position, the clamping element 105-2 is pressed down slightly against the repulsive magnetic force and rotated into the closing position.

This movement is also supported by the magnetic elements 107-1 and 107-2, as they continue to act with the same polarity. As a result, the clamping element 105-2 shoots up to the stop into the end position, generating a metallic noise that indicates to the user that the clamping element 105-2 is in the closing position.

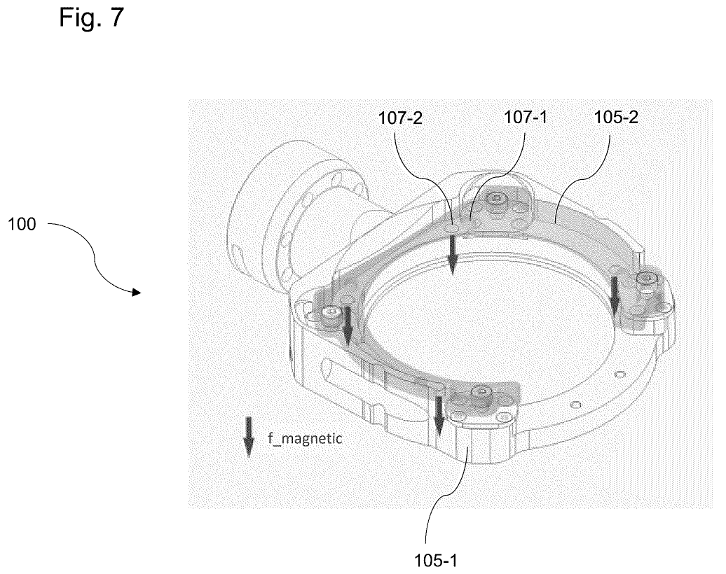

FIG. 7 shows another perspective view of the clamping holder 100 in the closing position. The clamping element 105-2 is ferromagnetic and is therefore attracted by the magnetic elements 107-1 in this state. The clamping element 105-2 is held down by the effect of the magnetic elements 107-1 in the clamping element 105-1 on the ferromagnetic base material of the clamping element 105-2. In addition, the laterally repelling forces between the magnetic elements 107-1 and 107-2 continue to act so that the clamping element 105-2 is held in the closing position.

In order to move the clamping element 105-2 out of this closing position again, a torque is exerted in the direction of the opening position. Due to the repulsive forces between the magnetic elements 107-1 and 107-2, the clamping element 105-2 shoots into the opening position. If a certain angle is exceeded, the clamping element 105-2 is pushed upwards again and floats in the opening position in the clamping holder 100. This also provides additional acoustic feedback in the opening position through a metallic stop of the clamping elements 105-1 and 105-2.

The magnetic elements 107-1 and 107-2 in the clamping elements 105-1 and 105-2 serve to improve the removal of the clamping element 105-2 within the clamping holder 100, so that floating of the clamping element 105-2 within the clamping holder 100 is achieved. The floating then makes it easily possible to remove the clamping element 105-2 and the dental blank 103. In addition, the effect is that the clamping element 105-2 can be tilted by pressing on one side, so that the removal of the clamping element 105-2 is further simplified. The clamping element 105-2 is held in the opening position by the repulsive magnetic forces.

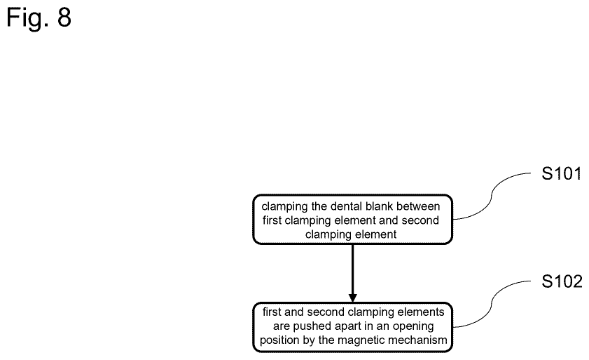

FIG. 8 shows a block diagram of a method of clamping the dental blank 103 in the clamping holder 100. The method comprises the step S101 of clamping the dental blank 103 between the first clamping element 105-1 and the second clamping element 105-2. In step S102, the first and second clamping elements 105-1 and 105-2 are pushed apart in an opening position by the magnetic mechanism 107-1 and 107-2.

The method enables easy clamping of dental blanks 103 in the clamping holder 100 with a high level of user-friendliness and user experience. Handling during tool-free clamping of the dental blank 103 is improved. Haptic and acoustic feedback from the clamping holder 100 is also improved. The position for closing the clamping holder 100 is held by the magnetic force effect. The position of the clamping element 105-2 for removal is raised and maintained in relation to the clamping element 105-1.

Potentially, the basic principle with the magnetic mechanism can be applied to any clamping holder 100 for a dental blank 103.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE LIST

100 Clamping holder
103 Dental blank
105 Clamping element
107 Magnetic element
109 Opening
111 Contact surface
113 Mechanical interface
115 Clamping pin
117 Contact surface
119 Protrusion
121 Opening

1. A clamping holder for a dental blank, comprising:
a first and a second clamping element for clamping the dental blank; and
a magnetic mechanism for pushing apart the first and second clamping elements in an opening position.

2. The clamping holder according to claim 1, wherein the magnetic mechanism is formed by a first magnetic element in or on the first clamping element and a second magnetic element in or on the second clamping element.

3. The clamping holder according to claim 2, wherein the first magnetic element and the second magnetic element are arranged with the same polarity.

4. The clamping holder according to claim 1, wherein the first and/or the second clamping element comprises a ferromagnetic material.

5. The clamping holder according to claim 1, wherein the first and/or the second magnetic element is arranged such that a clamping force is exerted between the first clamping element and the second clamping element in a closing position.

6. The clamping holder according to claim 1, wherein the first and the second magnetic element are displaceable or rotatable relative to each other.

7. The clamping holder according to claim 1, wherein the first magnetic element is integrated in a contact surface of the first clamping element to the second clamping element and/or the second magnetic element is integrated in a contact surface of the second clamping element to the first clamping element.

8. The clamping holder according to claim 1, wherein the first clamping element comprises several magnetic elements and/or the second clamping element comprises several magnetic elements.

9. The clamping holder according to claim 8, wherein the magnetic elements are arranged around a recess for inserting the dental blank.

10. The clamping holder according to claim 1, wherein the first and/or second magnetic element comprises neodymium.

11. The clamping holder according to claim 1, wherein the first and/or the second clamping element is C-shaped or ring-shaped.

12. A method of clamping a dental blank in a clamping holder, comprising the steps of:
clamping the dental blank between a first clamping element and a second clamping element; and
pushing apart the first and second clamping elements in an opening position by a magnetic mechanism.

13. The method according to claim 12, wherein a clamping force between the first clamping element and the second clamping element is exerted by the magnetic mechanism in a closing position.

14. The method according to claim 12, wherein the first and second clamping elements are pushed apart at several positions by the magnetic mechanism.

15. The method according to claim 12, wherein the first and second clamping elements are rotated between the opening position and the closing position.
